(19) United States
(12) Patent Application Publication
(10) Pub. No.: US 2017/0208760 A1
(43) Pub. Date: Jul. 27, 2017

(54) FARMING SYSTEMS

(71) Applicant: Jonathan LODGE, Buckinghamshire (GB)

(72) Inventor: Jonathan LODGE, Buckinghamshire (GB)

(21) Appl. No.: 15/328,293

(22) PCT Filed: Jul. 7, 2015
(86) PCT No.: PCT/GB2015/051965

§ 371 Date: Jan. 23, 2017

(30) Foreign Application Priority Data
Jul. 24, 2014 (GB) 1413112.2

(51) Int. Cl. A01G 31/04; A01G 1/00

(52) U.S. Cl. CPC A01G 31/04; A01G 1/001

(57) ABSTRACT

An apparatus for use in growing a plant crop, the apparatus comprising a structure enclosing a volume in which a crop can be maintained in a controlled environment during the growth of a crop, the structure housing two endless belts in spaced-apart parallel relationship and mounted for synchronous motion about a closed path, a trough to removably retain a nutrient solution for a crop, suspension means to enable a container holding a crop to be suspended between and move with the belts, the paths of the belts being such as to at least partially immerse the container in nutrient solution and feed a crop at least once on a complete belt circuit.

### CROSS-REFERENCE TO RELATED APPLICATIONS

This application is a national phase entry under 35 U.S.C. §371 of International Patent Application PCT/GB2015/051965, filed Jul. 7, 2015, designating the United States of America and published in English as International Patent Publication WO 2016/012748 A1 on Jan. 28, 2016, which claims the benefit under Article 8 of the Patent Cooperation Treaty to Great Britain Patent Application Serial No. 1413112.2, filed Jul. 24, 2014, the contents of each of which are incorporated herein in their entirety by this reference.

### TECHNICAL FIELD

This application relates to a system of growing vegetables and an apparatus for use in this system. The system finds particular use where the available area for growing is limited, and especially on a rooftop of a building.

### BACKGROUND

Given an increasing need to produce more food crops from a decreasing area of available land, and also to use as little fossil fuel-derived energy as possible in that production, many different techniques have been developed that improve yield per m² with minimal energy input. Additionally, techniques have been developed enabling previously unusable areas to support crops.

For example, particularly in urban environments, roofs of buildings are increasingly being used to grow crops. Where the rooftop is capable of supporting the weight, conventional greenhouses can be erected. Alternatively, containers or raised beds are located on a strong flat roof and growing is carried out in a manner used in conventional rural market gardens.

In attempting to utilize roof space and for an enterprise to be run commercially, one problem that needs to be addressed is that of tending and harvesting the crop. Many supermarkets have rooftop areas available. In a recent calculation, there were 2160 supermarkets, each having in excess of 5000 m² available. The use of this area could be exploited by utilizing modern polytunnel structures with a potential capacity of such a supermarket to grow crops with a value of £3 million per year. The process would benefit from directing the heat and carbon dioxide from boiler flue gases into the polytunnels, thereby improving conditions for growth.

However, simply utilizing polytunnels as part of a commercial rooftop farming enterprise retains the problem of land-based enterprises in that access is still required for farming machinery and for the workforce. The need for access removes a relatively large area from availability for cultivation. Additionally, when working in a rooftop environment, safety measures need to be undertaken to minimize the risk of falling from the rooftop, particularly of personnel, but also of equipment and materials. Moreover, the use of polytunnels is not suitable where the rooftop is pitched and is not a horizontal flat roof

One solution to the access problem uses hydroponics to deliver water and nutrients to the plants. There are two basic variants of hydroponics. In the first variant, individual pots containing plants are linked to an array of pipes that delivers what is required by the plant for growth. Due to the time required to set the pipework up, this variant is more advantageous for plant crops with a long growing period such as tomatoes. However, because of the need for access, not just to the crop but also to the pipework, a relatively large access area is still required. The second variant, which is often used for crops with a short growth cycle, such as salad leaf crops, utilizes polystyrene trays that float in tanks holding nutrient-enriched water. The tanks are usually relatively long, with the trays floating adjacent to each other from a first end when the plants are young, to a second end where the plants are grown and can be harvested. The nature of this second variant restricts growing crops to a single layer.

This disclosure seeks to address the above problems by providing a system for growing crops suitable for use on a rooftop, which improves space utilization and also safety of personnel. The system is also suitable for use in conjunction with sloping roofs.

### BRIEF SUMMARY

According to a first aspect of the disclosure, there is provided an apparatus for use in growing a plant crop, the apparatus comprising:
a structure enclosing a volume in which a crop can be maintained in a controlled environment during the growth of a crop,
the structure housing two endless belts in spaced-apart parallel relationship and mounted for synchronous motion about a closed path,
a trough to removably retain a nutrient solution for a crop,
suspension means to enable a container holding a crop to be suspended between and move with the belts,
the paths of the belts being such as to at least partially immerse the container in nutrient solution and feed a crop at least once during a complete belt circuit.

The apparatus enables a crop to be grown within a relatively small volume, with minimal input from an operative.

Optionally, the suspension means includes a framework to hold one or more containers, which enables the crops to be removed, together with the container for further transportation, and for a new crop to be added relatively easily to pass through the apparatus. In addition, the suspension means includes a bar or axle attached to and extending between the belts to provide a secure support.

Conveniently, each belt is mounted to a drive sprocket, with the path of each belt being conveniently defined by a plurality of idler cogs, which additionally provide support to the belts. Further, the drive sprockets are conveniently located within the structure. The drive belts are preferably chains.

The apparatus preferably includes sensors, such as temperature or humidity sensors, these sensors being connected to a display enabling an operative to control the environment within the structure. Optionally, the sensors are linked to a processing means and a control means to enable the environment within the structure to be automatically controlled.

Optionally, one or more cameras are located within the structure to provide a visual image and/or record of the growth of the plants.

Preferably, one or more lasers are mounted within the structure to enable growth control of plant materials within the structure and reduce the requirement for herbicides during the growth of a crop.

The apparatus preferably includes a pump to respectively fill and empty the trough.

Preferably, the floor of the structure consists of a building roof that can enable crops to be grown close to a point of sale in an urban environment.

According to a second aspect of the disclosure, there is provided a method of growing plants, the method comprising the steps of:
(i) placing a plant into a container;
(ii) freely suspending the container between two endless belts, the belts being arranged in spaced-apart parallel relationship and mounted for synchronized motion about a closed path,
(iii) adding a nutrient solution to a trough,
(iv) the path of the belts being such as to at least partially immerse the container and the plant through a nutrient solution in the trough to feed and water the plant and then to remove the container and plant from a nutrient solution and trough,
(v) the path being confined within a space having a controlled environment.

### BRIEF DESCRIPTION OF THE DRAWINGS

The disclosure is now described with reference to the accompanying drawings that show by way of example only, one embodiment of a farming system. In the drawings:

FIG. 1 is a diagrammatic illustration of a building including a rooftop farming system in accordance with the disclosure;

FIG. 2 is a side view of the building and system of FIG. 1;

FIG. 3 is a diagrammatic illustration, not to scale, of trays and a nutrient trough; and

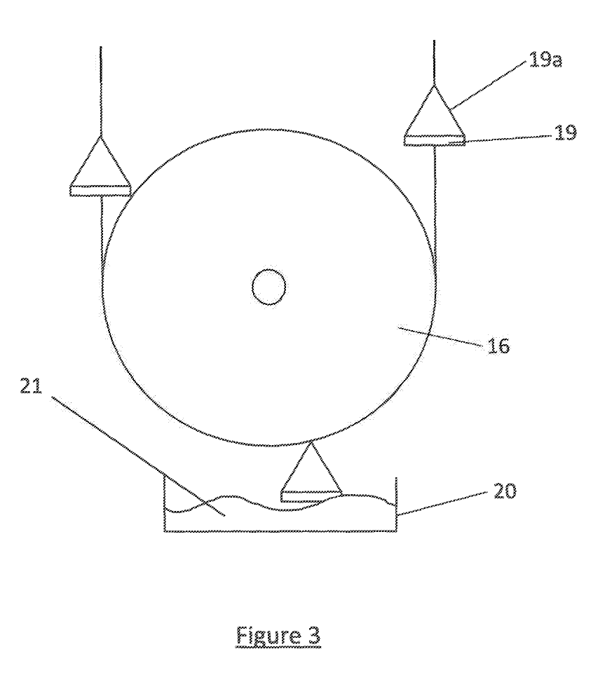

FIG. 4 illustrates a tray suspended between drive chains.

### DETAILED DESCRIPTION

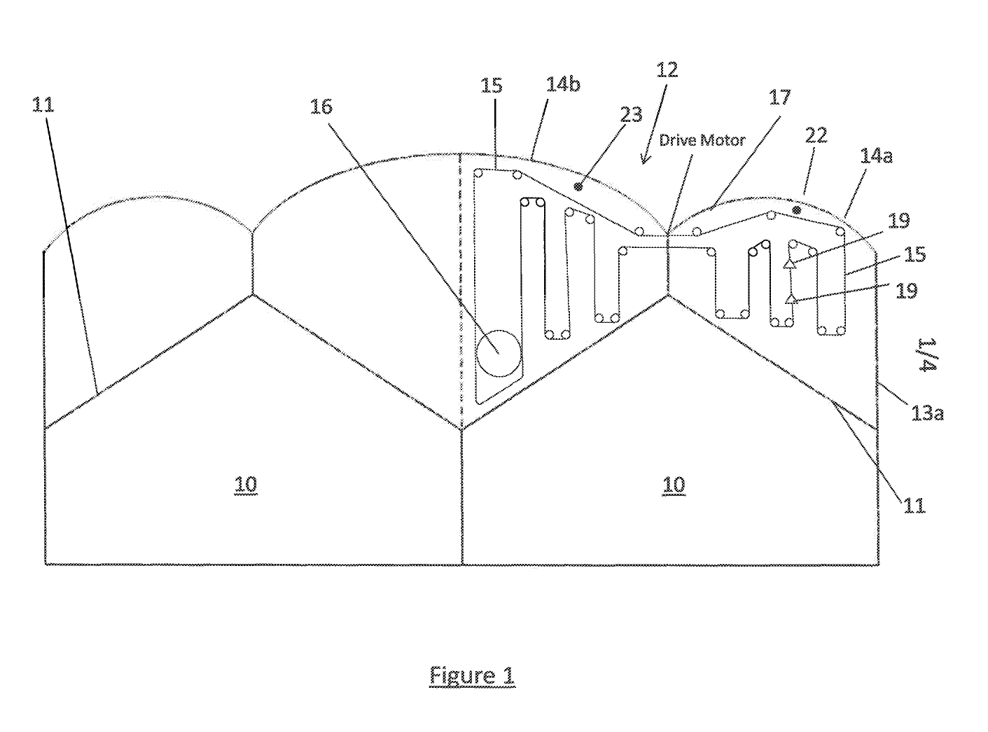

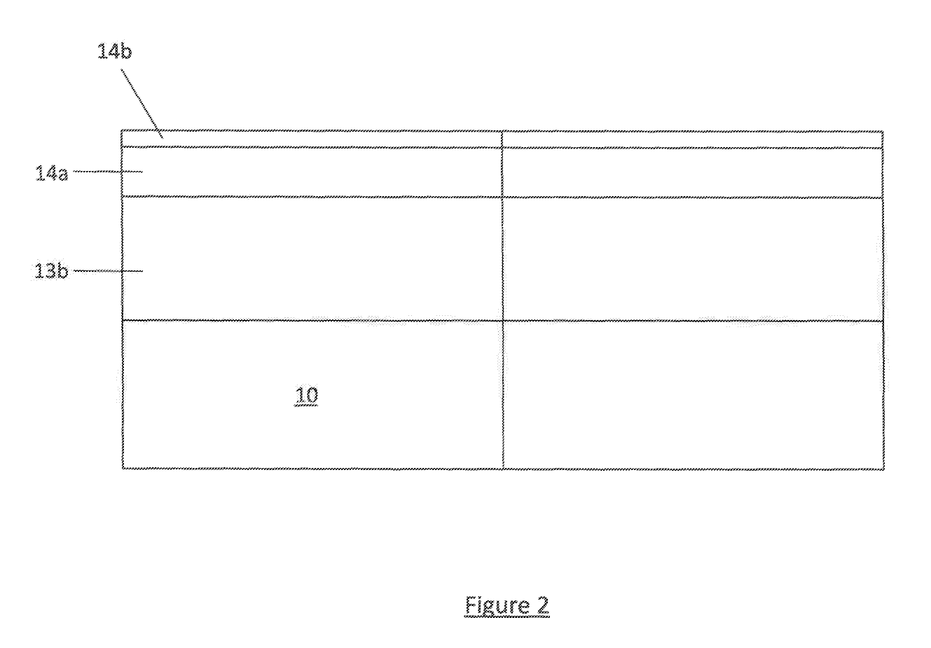

Referring to FIGS. 1 and 2, these illustrate a modular system located on the rooftop of a building. The building rooftop is of design that is common for modern warehouses and also supermarkets, especially those constructed as part of a purpose-built industrial retail park. In such buildings, a basic steel frame is erected and cold-rolled steel purlins bolted thereto. The purlins are then covered with the insulated steel profile sheets. Larger buildings can be put together with several low-pitched bays.

The modules erected on the roof 11 of the building 10 can be installed to suit the frame of the building 10 and with minimal disturbance of the frame either during or subsequent to construction. In addition, it is intended that the weight of a module be borne, where possible, by the building frame. A basic module, generally referenced 12, therefore, comprises a steel framework having walls and a roof made of a plastics material. The plastics material is known in the art and is already widely used for the construction of conventional polytunnels. Moreover, the plastics material is available as a roll, approximately two meters in width and the modules can be constructed using the known Keder method. In this method, the framework of the module is erected, and includes regularly spaced arches across which the plastics material is attached to form a roof of the module. A roof can, therefore, be constructed from several strips of plastics material going across the width of the module or, alternatively, a single length of plastics material running the length of the module.

Within the module, an almost completely automated process enables the growing plant to be monitored, watered and fed, and harvested. Additionally, means are optionally included to control weeds and pests.

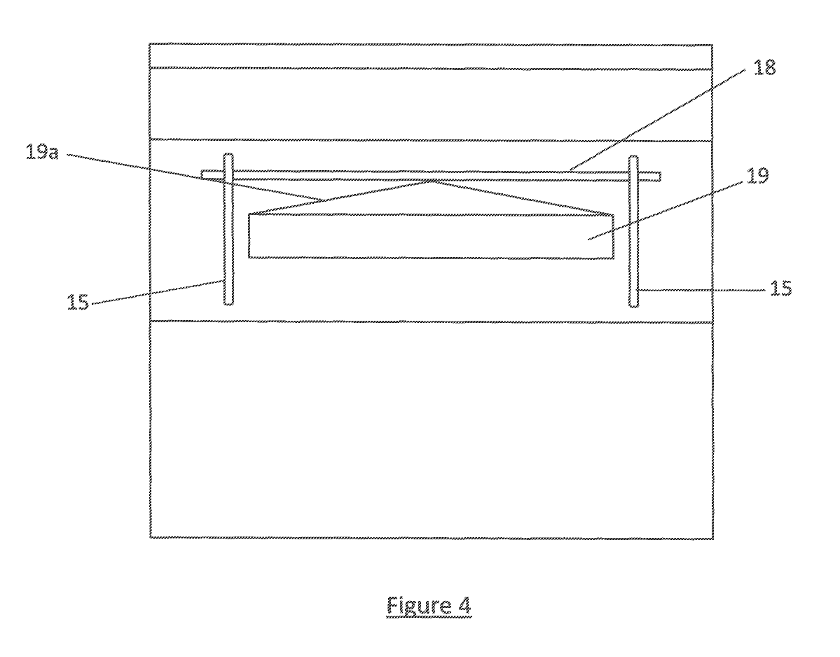

Within the internal volume of the module generally referenced 12, and defined by the building roof 11, module walls 13a, 13b and module roof 14a, 14b is maintained a controlled environment in which the crop is grown. A pair of parallel endless drive belts, or as herein exemplified, chains, approximately two meters apart, only one of which chains 15 is shown in FIG. 1 for convenience, are utilized to transport plants through the module 12. The chain 15 is driven by a main drive cog 16 and the path of the chain is effectively determined by the idler sprockets 17. The drive cog 16 is driven by a motor located where shown in FIG. 1. At spaced intervals along the chain 15, bars or axles 18 (see FIG. 4) extend between and are fixed at either end to the chain 15. In an alternative embodiment, not illustrated, a cable or chain can replace the bar or axle.

In use, containers 19 in which plants are retained are suspended by cables 19a from the axles 18. In an advantageous embodiment, not illustrated, the containers 19 are held in a common framework, enabling a container 19 to be removed, the crop harvested, a new crop planted in the container 19 and the container 19 then put back into a framework. In order to reduce costs therefor, it is envisaged that the framework is so sized as to accept an integer number, especially three, industry standard-sized containers. Such containers are available in a wide variety of shapes and sizes and can themselves carry smaller trays or pots. By using industry standard containers, the costs are kept to a minimum. In particular, certain trays are available that hold potted plants, such that the potted plants do not fall over and that fit into Danish trolleys, used within a supermarket or horticultural outlet. Although normally single use, trays can be reused with this disclosure, which again reduces costs.

It will be noted, therefore, that as the main drive cog 16 turns, the chain 15 and the containers 19 suspended therefrom are transported around the module 12 and the plants, therefore, are moved from one region of the module 12 to another. At defined points along this course, the light conditions, humidity, etc., can be monitored, and feeding and weed and pest control can be undertaken. The trays can be provided with RF tags or Bar/QR codes, which can be read by sensors at various points, for example, as a tray approaches a watering trough or a transfer point (see below).

One advantage of the disclosure described herein over prior art systems is that of being able to be installed on roofs of different shapes and dimensions, without needing to manufacture elements specifically for that roof or plant crop. The configuration of the path of the chain 15 is determined by the idler sprockets 17 and, therefore, these can be positioned to suit the general roof shape and any other installations that may be present on the roof 11.

The above system enables a much simplified watering and feeding regime to be implemented. Unlike prior art systems that require a large number of pipes and branches to water individual plant-containing pots or that require the pots to be located on a capillary matting, the present system can comprise a single watering point consisting of a trough 20. The trough 20 can be filled with water and any nutrient solution 21 for the particular plant and its stage of growth. The trough can be filled either by hand or by utilizing a pump. As the plant is moved along its path by the chain 15, the plant is dipped into the trough 20, thereby watering and/or feeding the plants. Should the particular plant require it, the movement of the chain 15 can be paused to ensure thorough watering.

Once the watering and/or feeding is completed for that container, the trough 20 can be emptied, again optionally by means of a pump, ready to receive fresh water and nutrients 21. As the containers move on, any excess water dripping from the plants runs back into the trough 20 and can be reused. An advantage of this method of watering is that as the water drains from the plant, air is sucked into the soil, enhancing the soil's ability to support growth.

In order to monitor the progress of the plants, sensors are installed at points within the module 12 and also cameras so that the visual status of the plants can be observed. In FIG. 1, a number of detectors is shown. First, a temperature indicator is shown at 22 and, second, a humidity indicator at 23. It should be appreciated that the detectors can be positioned elsewhere within the system as best determined on setting the system up. Conveniently, sensors can be located in the region of the trough 20. The sensors can, in particular, include a barcode reader, camera or laser. The sensors are conveniently linked to a central processing and control unit, which will be programmed to take the actions necessary to keep the values of various properties such as temperature within a preset range. Alternatively, the unit can simply provide read outs when it is required that the values be maintained manually.

The use of sensors not only allows for conditions to be controlled but also to provide information to retailers that they can use as a marketing tool within that business.

First, the data can be accumulated and can be used to enable the grower to build a knowledge base to aid in their understanding of how to manage conditions within the modules to ensure best growth.

Additionally, the data can be used to show customers, either through labels on the goods or through screens throughout the store, the provenance of the goods. A further use for the data would be as part of a smartphone app to enable customers/consumers to receive direct camera feeds to determine when a crop is ready. Also, crops at different stages of development can be harvested and brought down for educational purposes to show students in the building below.

Finally, the images from the cameras can be used to give a time-lapsed film showing growth of a plant.

The information from the cameras can also be linked to a processor that is linked to a laser. The laser can be mounted at a convenient point within a module in line of sight of the trays/containers and because all the plants within a module pass that point, all the plants should at some time come within the line of sight of the lasers. The laser can then be used, under the control of a processor, for example, to remove weeds or to trim unwanted roots, stems or leaves or perhaps to thin out plants in a tray. The requirement to use herbicide is, therefore, reduced.

Where space allows, modules can be located side by side along a roof and, assuming temperature requirements between adjacent modules allow it, share a common dividing wall. Depending on the crops being grown, adjacent modules can either share a watering trough or be provided with their own individual trough. In the former situation, coordination between chain movement and delivery of a crop to the common trough can be carried out to minimize the frequency of filling and emptying a trough, particularly where the same solutions are used for both crops. The use of individual troughs would, of course, remove the requirement for that level of coordination and would also enable the growing conditions for each crop to be individually optimized.

When using a plurality of modules, there is an increased need to maximize the growing space available and also to enable the system to remain predominantly automated. To achieve this and to enable as high a density of plant growth as possible, a number of access points to a module is reduced to the minimum possible. Moreover, produce from each module is brought to a single access point, from where it can be removed from the roof to, for example, the supermarket floor. For convenience, an access point can be in the region of trough 20. This facilitates the process of watering, weeding, pruning, etc., as these actions can first be monitored visually in a control area, and second, take place while the plants are stationary. In order to minimize the requirement for physical labor to be used to move produce, robotics and CNC machining techniques can be utilized to lift plant trays/containers from frames and to place them on a transport frame. The transport frame is then carried by means of a pair of chains that give a route across the roof to the access point. By suitable routing, a growing area of several thousand square meters can be accessed from a very small area, perhaps no larger than a lift shaft.

Again, the use of a single access area provides a great deal of flexibility in respect of where the access area can be located within the building or whether even on the outside of the building. As long as the layout allows for an adequate corridor for the transport frame, the positioning of the access area to the ground floor can be anywhere on the corridor. Of course, where a system is installed at ground level, or on a rooftop on which human access is not restricted, then a crawler frame may not be required.

1.-15. (canceled)

16. An apparatus for use in growing a plant crop, the apparatus comprising a structure enclosing a volume in which a crop can be maintained in a controlled environment during the growth of a crop,
the structure housing two endless belts in spaced-apart parallel relationship and mounted for synchronous motion about a closed path;
a trough to removably retain a nutrient solution for a crop;
a number of containers for holding a crop and suspension means to enable said containers holding a crop to be suspended between and move with the belts;
the paths of the belts being such as to at least partially immerse the container in nutrient solution and feed a crop at least once on a complete belt circuit;
wherein each belt is mounted to a drive sprocket and the path of each belt is defined by a plurality of idler cogs;
wherein the floor of the structure consists of a building roof and the plurality of idler cogs are positionable within the volume of the apparatus to suit the shape of the building roof on which the apparatus is located; and
wherein the structure is formed of a plurality of modules that are installed so as to suit the shape of the building roof, wherein at least one of said modules comprises a single access point from where crops can be removed from the volume of the apparatus.

17. The apparatus according to claim 16, wherein the suspension means includes a framework to hold a number of containers.

18. The apparatus according to claim 16, wherein the suspension means includes a bar attached to and extending between the belts to provide a secure support for the container.

19. The apparatus according to claim 16, wherein the drive sprockets are located within the structure.

20. The apparatus according to claim 16, wherein the plurality of idler cogs additionally provide support to the belts.

21. The apparatus according to claim 16, wherein the drive belt is a drive chain.

22. The apparatus according to claim 16, wherein the apparatus includes sensors, said sensors being connected to a display enabling an operative to control the environment within the structure.

23. The apparatus according to claim 22, further comprising a processing means and a control means, wherein the sensors are linked to said processing means and said control means to enable the environment within the structure to be controlled automatically.

24. The apparatus according to claim 16, wherein a number of cameras are located within the structure to provide a visual record of the growth of the plants.

25. The apparatus according to claim 16, including a pump to fill and empty the trough of nutrient liquid.

26. The apparatus according to claim 16, wherein a number of lasers are mounted within the structure.

27. A method of growing plants, the method comprising the steps of:
(i) providing a structure enclosing a volume in which a crop can be maintained in a controlled environment during the growth of a crop, wherein the floor of the structure consists of a building roof and the structure is formed of a plurality of modules that are installed so as to suit the shape of the building roof, at least one of said modules comprising a single access point;
(ii) placing a plant into a container;
(iii) freely suspending the container between two endless belts, said belts being arranged in spaced-apart parallel relationship and mounted to a drive sprocket and a plurality of idler cogs for synchronous motion about a closed path;
(iv) positioning the plurality of idler cogs within the volume of the structure to suit the shape of the building roof on which the structure is located;
(v) adding a nutrient solution to a trough;
(vi) the path of the belts being such as to at least partially immerse the container and the plant in a nutrient solution to feed and water the plant and then to remove the container and plant from the nutrient solution;
(vii) the path being confined within a space having a controlled environment;
(viii) removing a crop from the volume of the structure via said single access point.
